(19) United States
(12) Patent Application Publication
(10) Pub. No.: US 2008/0052375 A1
(43) Pub. Date: Feb. 28, 2008

(54) Systems and Methods of Network Operation and Information Processing

(76) Inventors: Jasminder Singh Banga, San Francisco, CA (US); Nitin Jayant Shah, Cupertino, CA (US); Brijesh Ramji Patel, Gilroy, CA (US); Amul Patel, Pacifica, CA (US)

Correspondence Address: COURTNEY STANIFORD & GREGORY LLP, P.O. BOX 9686, SAN JOSE, CA, 95157, US

(21) Appl. No.: 11/933,325

(22) Filed: Oct. 31, 2007

Related U.S. Application Data
(62) Division of application No. 11/932,307, filed on Oct. 31, 2007.
Application No. 11/932,307 is a continuation of application No. 11/387,651, filed on Mar. 22, 2006.
(60) Provisional application No. 60/664,322, filed on Mar. 22, 2005.

(51) Int. Cl. G06F 15/16

(52) U.S. Cl. 709/217

(57) ABSTRACT

Systems and methods are disclosed for network operation and information processing involving engaging users of a network. In one exemplary embodiment, there is provided a method of engaging users of a public-access network. Moreover, the method includes associating a processing component with the public-access network; transmitting a request for authorization to use the public-access network, including transmission of a specific identifier associated with the user; transmitting first data including data determined by processing software as a function of the specific identifier; and opening up a connection to the network for the user. In one or more further embodiments, the specific identifier may include or be a function of a processing component ID or the MAC address of a device associated with the user. Other exemplary embodiments may include building profiles of users who access the network based on information collected.

### CROSS REFERENCE TO RELATED APPLICATIONS

This is a continuation of application Ser. No. 11/387,651, filed Mar. 22, 2006, published as US2007/0011268A1, which claims the benefit of U.S. provisional patent application No. 60/664,322, filed Mar. 22, 2005, all of which are incorporated herein by reference in entirety.

### BACKGROUND

1. Field

The present invention relates generally to systems and methods of network operation and information processing, and more specifically to systems and methods that involve engaging users of a network.

2. Description of Related Information

Existing systems for network operation and information processing typically engage users of a network without using or acquiring particularized information regarding the user, the user device, and/or previous usage information. The failure to use or acquire particularized information results in a variety of drawback for such systems, such as the need to charge for network access and the inability to deliver the most effective content. Further, the failure to acquire and subsequently process this particularized information can prevent such systems from delivering the most effective content throughout the entire engagement process or period.

For example, internet users often obtain information from content-rich sites on the web such as news related sites or portals that offer links to sites that offer the content users are seeking, or through search engines that scour the web to glean the information users seek. Vendors, ad-serving entities and web sites use a variety of techniques in a primary objective of delivering content that elicits a desired response from the recipient (e.g., content that includes one or more commercial activity motivating aspects, such as a revenue-generating feature). In this regard, the accumulation of information concerning the recipients or prospective recipients of the content encompasses numerous methods and technologies, including profiling, tracing usage, using markers to track behavior, etc. Drawbacks with these methods, however, oftentimes center around their inability to provide precisely targeted content and/or to inject appropriate localized content (e.g., advertising) directly into the various distributions or streams of information bound for each end user.

Therefore, a need exists for efficient, easy to deploy, adaptive learning systems that use and accumulate website-independent user-profile related information, and that are capable of updating, adaptively processing and delivering targeted content in real-time to an increasingly mobile computing community

### SUMMARY

Systems, methods, and articles of manufacture consistent with the invention are directed to network operation and information processing involving engaging users of a network. As seen in the specification below and the materials attached hereto, various embodiments of such systems, methods, and articles of manufacture are disclosed.

In one exemplary embodiment, there is provided a method of engaging users of a public-access network. Moreover, the method includes associating a processing component with the public-access network; transmitting a request for authorization to use the public-access network, including transmission of a specific identifier associated with the user; transmitting first data including data determined by processing software as a function of the specific identifier; and opening up a connection to the network for the user. In one or more further embodiments, the specific identifier may include or be a function of a processing component ID or the MAC (machine address code) of a device associated with the user. Other exemplary embodiments may include building profiles of users who access the network based on information collected.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of several further features disclosed below in the detailed description.

### BRIEF DESCRIPTION OF THE DRAWINGS

The accompanying drawings, which constitute a part of this specification, illustrate various embodiments and aspects of the present invention and, together with the description, explain the principles of the invention. In the drawings:

FIG. 1 is a block diagram of an exemplary computer system consistent with certain aspects related to the present invention.

FIG. 2 is a block diagram illustrating an exemplary system and processes for implementing network operation and information processing, according to one or more embodiments of the present invention.

FIG. 3 is a block diagram illustrating an exemplary system and processes for implementing network operation and information processing, according to one or more embodiments of the present invention.

FIG. 4 is a chart illustrating exemplary features of implementing network operation and information processing, according to one or more embodiments of the present invention.

FIG. 5 is a block diagram illustrating an exemplary system and processes for implementing network operation and information processing, according to one or more embodiments of the present invention.

FIG. 6 is a flow diagram illustrating an exemplary process for implementing network operation and information processing, according to one or more embodiments of the present invention.

FIG. 7 is a flow diagram illustrating an exemplary process for implementing network operation and information processing, according to one or more embodiments of the present invention.

### DESCRIPTION OF THE EMBODIMENTS

Reference will now be made in detail to embodiments of the invention, examples of which are illustrated in the accompanying drawings. The implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

Many systems and environments are used in connection with networks, network operation, and associated information processing. These systems and environments can be implemented with a variety of components, including various permutations of the hardware, software, and firmware disclosed below. Exemplary system architecture for the embodiments of systems and methods of network operation and information processing disclosed throughout this specification is set forth as follows.

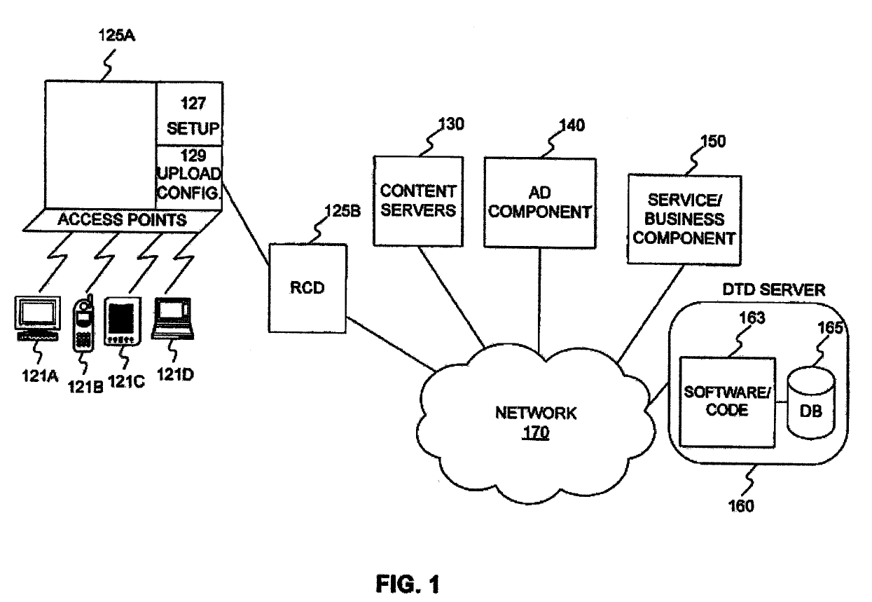

FIG. 1 illustrates a block diagram of an exemplary system consistent with one or more embodiments of the present invention. While the description of FIG. 1 is directed to the following exemplary hardware and software elements, the components of the system can be implemented through any suitable unitary or distributed combination of hardware, software and/or firmware. Referring to FIG. 1, the illustrated system includes access devices 121A-121D, one or more components such as Routing/Connectivity Devices (RCDs) 125A and 125B, and a processing component such as a Device and Targeting Database Server (“DTD Server” or “DTDS”) 160, typically connected via a network 170 such as the World Wide Web. Data processing between the RCDs 125A and 125B, the access devices 121A-121D and their users, and the DTD Server 160, over the network 170, is used to implement various aspects of user engagement, user identification and user profiling functionality disclosed herein. For example, a request, associated with a user of an access device 121A-121D, for authorization to use the network may be transmitted from access devices 121A-121D to the DTD Server 160. Similarly, first data in reply to this request may be transmitted via DTD Server 160 back to the access device 121A-121D. As used herein, “first data” refers to initial data, information, pages and/or content intended for transmission to user access device, including but not limited to pages such as initial pages, splash pages, home pages, terms & conditions pages, acceptance pages, first pages, and/or other pages, as well as other information of relevance based on user-specific information. Further, any combinations of these pages and this information may be served to accomplish various objectives such as to minimize page transmission, to present ads or other desired material, to provide information targeted to the specific used, and/or to effect a logical order of any other user interaction addressed herein.

In the exemplary embodiment illustrated in FIG. 1, the Routing/Connectivity Device is comprised of a first RCD component 125A (e.g., an access point) and a second RCD component 125B (e.g., a gateway, a router, etc.), although the RCD may readily be implemented as a unitary or otherwise distributed system element(s). The first RCD component 125A may also include a setup component 127 and an upload configuration component 129, which can be customized for the particular application, location or use. DTD Server 160 may be comprised of a database 165 and a software/code component 163, although data such as user profile data may also be stored in one or more external databases. Additional elements may also be associated with the network 170, such as Content Servers 130, Ad Components 140, and Service/Business Components 150, although these components can also be integrated into or combined with other elements of the system, or eliminated altogether, according to one or more embodiments of the present invention.

The information stored in DTD server 160 such as user profile information may be updated over network 170 using information gathered by RCDs 125A and 125B from users 121 connecting with or attempting to connect to the network. In some embodiments RCD 125A may request user and device profile information from the DTD Server 160 if the particular user or device has accessed the system on a prior occasion. In some embodiments, user or device profile information may be downloaded to a local network cache (not shown) for quicker access. In some embodiments, according to the present invention, multiple DTD servers may be used and physically and geographically distributed across network 170. According to one or more embodiments of the present invention, a processing component such as DTD Server 160 is associated with the public-access network. In this context, “associating” means that the processing device: (1) has been or is presently connected to the network, either physically or functionally in a manner allowing data exchange, (2) is involved in activating a new connection between the processing component and the network, or activating one that already exists, or (3) enables or commences processing consistent with the methodologies disclosed herein. Further, processing software is “associated” with the processing component in that it can either be physically contained within or connected to the processing component, or that it may be a distributed element located elsewhere on the network. Network 170 could be a LAN, WAN or the Internet. Further, a request for authorization to use a network is associated with a user of an access device in that the request may either be an explicit instruction of the user or it may simply be the result of the user's innate access device functionality. In some embodiments, the RCD 125 could be consistent with existing access point (“AP”) systems such as remote wireless access points/servers from generic providers, for example, Proxim, Linksys, Dlink, Compex, Buffalo Technologies, Netgear, Terabeam, Nomadix, and Plug Inn Go, etc. In some embodiments, the present information processing system may also be used or implemented with wired technology. Embodiments of the present system may also include signal amplifiers, external antennas, signal splitters, and other standard equipment as components.

In some embodiments, the servers and related systems shown in FIG. 1 may be standard off-the-shelf components or server class computers. For example, the DTD Server 160 of the present invention may be implemented with, for example, Microsoft's (“MS”) SQL Server, and the web server can be a MS IIS server. Additionally, any other programs or code capable of accessing and/or providing information in the database may also be used. In further embodiments, the system, servers, and/or system elements may use languages such as SQL, XML, SOAP, ASP, and HTTP, etc., to enable data transmission and processing, although any suitable programming language or tool could also be used.

Systems and methods of the present invention can be implemented on a variety of networks, including wireless networks such as WiFi, WiMAX, and any mobile Ethernet network. Systems and methods can also be implemented on wired and other networks, such as Cable, DSL and Fiber-based broadband networks, or any combinations of wired and wireless networks (e.g. combined Cable+WiFi). Certain embodiments of the present invention, as set forth herein, pertain to wireless/WiFi systems (not limited to varieties of WiFi 802.11b/a/g/n mobile Ethernet standards) and associated methods of information processing. Referring to FIG. 1, an exemplary embodiment that may sustain an internet zone or service offered freely to the public is consistent with the system disclosed. Such a service may also be based on subscription or pre-pay charges, or some combination of carrier subsidy, consumer fees, and/or completely free access. In some cases, where the network is used for both public access and for private networks (e.g. Government, Municipal or Enterprise/Campus users), the same basic system can also be used. Systems enabling free usage, for example, may be facilitated by information processing that includes location-based services provided via ‘sponsors,’ such as commercial enterprise sponsors. These sponsors benefit from the targeted content delivery and user profiling features provided by the present systems and methods. Accordingly, these sponsors implement embodiments wherein they absorb the costs normally required of the users, According to these embodiments, an engine or server including end user authorization functionality such as provided by the DTD Server, is used to transmit commands back to RCPs (e.g., access points, etc.) or servers (e.g., ad servers, authentication servers, content servers, etc.) to open up a connection to the Internet. Such connection may be unrestricted, or it may be restricted by bandwidth limitations per user or by other limitations deemed necessary to maintain the QOS (quality of service).

The DTD Server 160 can also include central authorization software that enables the system to scale to hybrid public Internet access networks across the world by controlling the end user but having the option of not managing various remote hardware, such as a remote router. By managing the AP or server (e.g., element 125A) and not the router (e.g., element 125B) at remote locations, this remote point of entry network device can co-exist with existing deployed networks with very few barriers. For example, an existing network may have 1 megabyte pipe up and down, but the provider may benefit by allowing a free Internet zone in its place of business where the unused amount of network bandwidth can be used, and so may limit the public zone with 256 kbps up and 700 kbps down, and limit each user to no more than 128 kbps up and 500 kbps down each. Further, the DTD Server site profile can be updated centrally and apply the policy when the request comes from a user, as well as to adjust the bandwidth based on time of day and any other QOS reasons.

These WiFi/UN engine embodiments collect and provide pertinent information about a user by virtue of collecting information about the access device associated with the user. Thus, the information is anonymous in the sense that it is not a profile of an individual per se, but rather information associated with a computing device they use. This information can be related to the device, the temporary or permanent software on the device, and any user-input data which is resident on the device. All these data are captured and retained, and indexed with an identifier such as MAC or other user identifier (UID) so the information from a repeat user can be verified and enhanced each time the same device accesses the network. Acquired information can be, for example, the full range of unrestricted information typically sought by commercial entities, including name, address, and other personal data. The acquired information can also be limited in its scope, as certain prohibitions may dictate that end user name, race, phone numbers, addresses, etc. are not collected/disclosed in adherence to restrictions or local laws such as those directed to privacy.

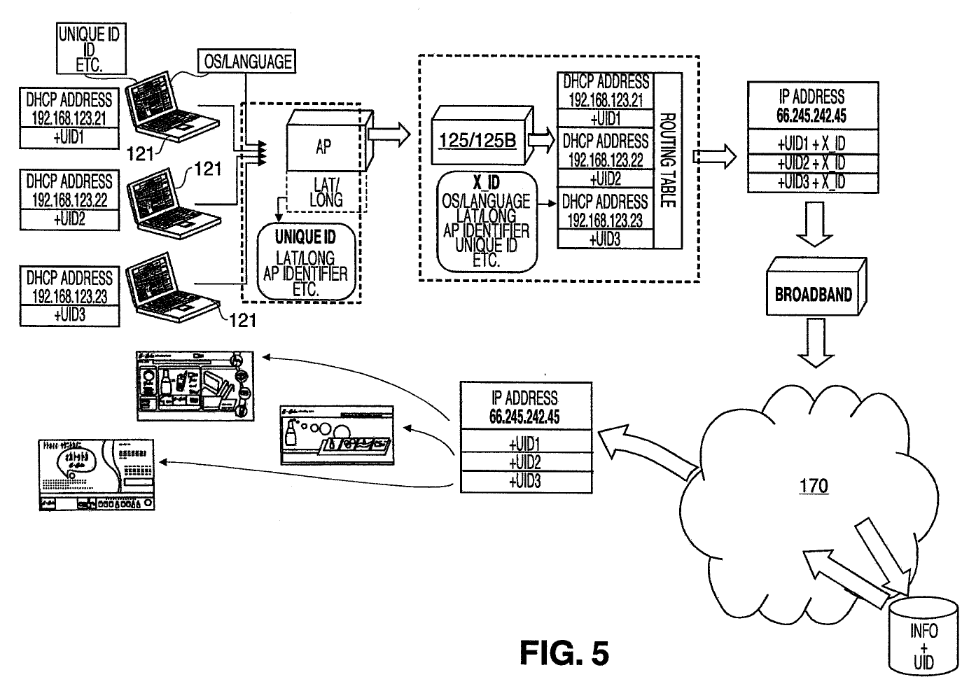

Embodiments of the system of FIG. 1 can also include a profile engine (not shown), which includes the ability to process identifier data such as MAC addresses and/or any other specific software- or hardware-based user identifier (UID). The profile engine may be a component of the DTD Server 160, though it may also be distributed anywhere within the system of FIG. 1. In one or more embodiments, the profile engine may include an algorithm designed to profile the identifier data/user based on the frequency and locations that the associated access device joins a network, coupled with other user data such as answers to survey questions and/or other user actions or responses. The calculated profile information can be correlated in the processor, weighted according to value (such as incremental numeric value), and then placed in profile groups or Pools to enable correlation with sponsors interested in that type or group of users. Pools are survey-related groupings, and are described in more detail in connection with FIG. 5, below. When a user requests to join the network, the identifier can be associated with a location tag, and the request associated with this information can be matched up with an appropriate sponsor for that location. Content highly targeted to the user is thereby enabled, including customized content from third-party databases that contain information related to the location. For example, the customized content may include information about the location itself, places, attractions, and events in the proximity of that location, as well as information related to what has happened and what will happen in that locality (e.g. historical events, future community or concert events, sale events planned at the local stores, etc.).

According to these embodiments, the profile engine can provide highly relevant, targeted information, advertising or specific services that are unique to each user from the same network. Further, repeated access to the network by a user enables the profile engine to collect more and more network usage information for the user or associated access device. Additionally, the profile engine may also determine trend rates per geographic zone, which is of value to advertisers in the local region or remote sponsors seeking local presence. This can allow for local advertising, local billing of services, and the ability of nationwide advertisers and brands to customize their content according to a location or groups of locations with similar characteristics (e.g. all neighborhoods in the mid-west with a local temperature of over 80 Celsius or all neighborhoods in the Pacific North-West with largely Asian enthnic demographics).

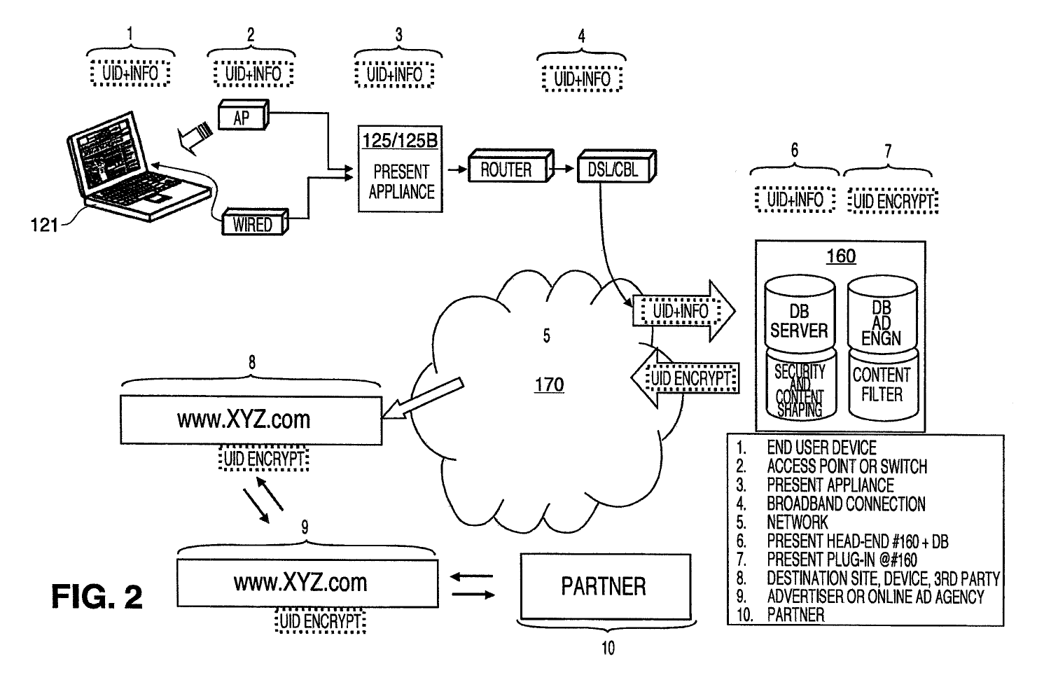

In some embodiments, when an end-user browses web sites using a computing device, the RCD 125 collects information regarding browsing habits and relays this information to DTD Server 160, where a database profile for the user and/or device may be updated. In some embodiments, the RCD 125 may also download information from DTD Server 160 and modify and send some of this information to content servers such as Content Server 130, to ad-related entities or components such as Ad Component 140, and/or to service providing entities or components such as Service/Business Component 150. In some embodiments, user and/or device profile information received by Content Server 130 from either the RCD 125 or the NDP server 160 may be used by Content Server 130 to determine which advertisements to retrieve from Ad Component 140. FIG. 2 illustrates one representative architecture for exemplary targeted-advertising business methods/models, according to one or more embodiments of the present invention. The embodiment of FIG. 2 illustrates the interrelationships between some of the systems, sites, and entities associated with the targeted-advertising business methods and models disclosed herein. Specifically, FIG. 2 illustrates the basic architecture for information processing to and from these various system elements and entities.

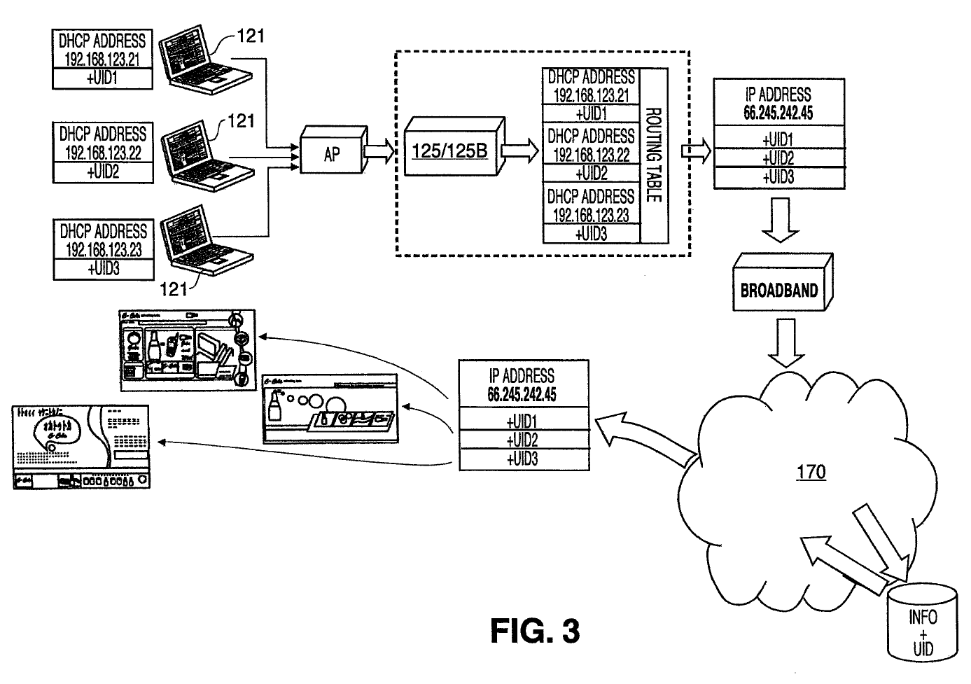

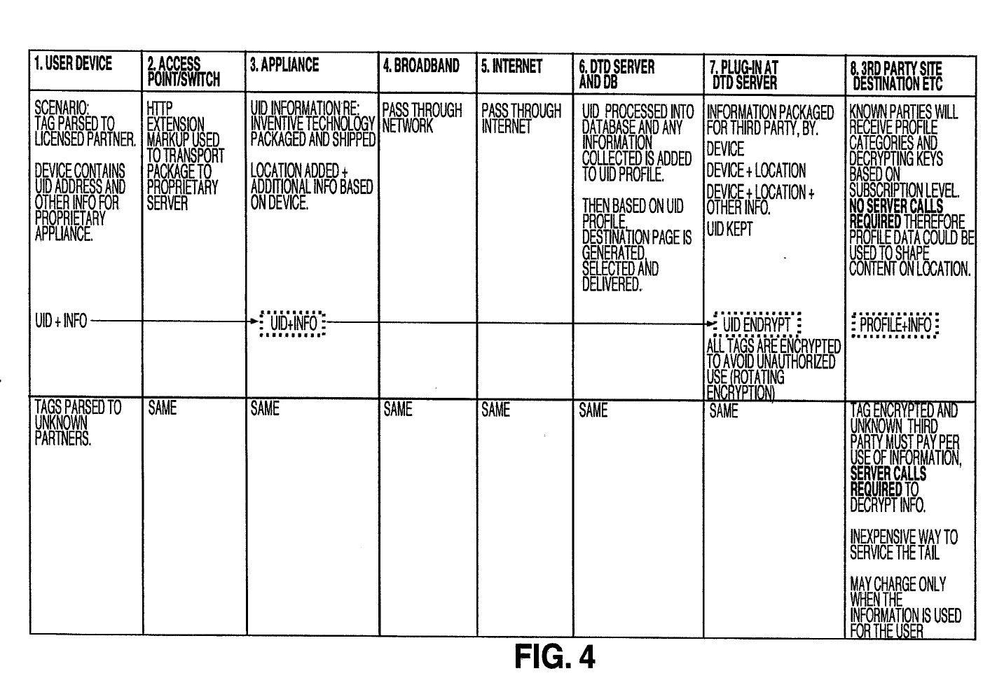

FIGS. 3-4 are exemplary implementations of identifier or unique identifier information use throughout all phases of network processing and information delivery. By means of the technology of the present invention, identifier or unique identifier information such as MAC address is collected and transmitted to the DTD Server 160 and associated database(s) for processing and re-transmission. The systems, servers, and software of the present invention, in the sense of their anonymous user embodiments, can also readily access, use, and process MAC addresses that are not in a clear format without negative impact on the value they add to the network actors who desire the key pieces of data. Thus, MAC addresses that are encrypted, encoded, corrupted, or otherwise not in their proscribed format are handled equally as dynamically by the present system. For example, a unique identifier consistent with the less-than-clear MAC can be assigned, with all of the remaining data association and information processing steps remaining the same. Additionally, a key or basic data keyed to the unclear MAC can also be generated and used. Moreover, the present system and software can encrypt the outgoing unique identifier information such that others privy to such data transmissions have no way of reverse engineering the MAC address from the communications and protocols of the present invention.

Content and advertising information are combined by Content Server 130 and sent to the RCD 125 for transmission to the users 121. In some embodiments, the RCD 125 may modify the content or advertising received over the network 170 based on device characteristics. For example, FIG. 5 illustrates additional exemplary information processing and delivery, according to one or more embodiments of the present invention. FIG. 5 illustrates how identifiers, unique identifiers including the MAC address and other location- or device-specific information, is handled by one exemplary implementation of the present invention. The MAC address, however, is not the only location identifier available and used in the present invention. The system of the present invention can obtain LAT/LONG (latitude and longitude information), or this data can be parsed to the present system by certain current wireless mesh network systems, which is then incorporated into location processing algorithms. Other devices or data points associated with a user, such as other wireless or WiFi devices having an imprint on our network connection, can be assayed and their signal and location integrated into our location parsing (as well as all other information processing and delivery). Additionally, as shown in the upper left portion of FIG. 4, the operating system (“OS”) and preferred language of the device and/or user can also readily be collected with or without the MAC address. In another example, if client 121 is a handheld device, the format of the content may be modified to better suit the screen and other characteristics of that handheld device.

Furthermore, the above-described systems may also include various system reporting features and functionality. For example, identifier information such as MAC and UID may be used to track a user as they travel from location to location, and an identifier algorithm engine may be used to process and provide other identifier-related information. According to these embodiments, the identifier algorithm engine can register the identifier in a database, including the time(s) of use, the AP (access point) location, and the user profile. Specific illustrations of this functionality are set forth below.

In an exemplary method of collecting and processing information consistent with certain aspects related to the present invention, an end-user first connects to a public network and launches a web browser. The browser is not allowed to access the default home page of the computing device, but rather is redirected to the DTD Server 160 over the network. Beginning with this very first handshake/data exchange whether through hypertext markup, radius accounting records, or back-channel communication, the DTD Server 160 acquires user profile and user identifier information, and begins saving this information to a database, this information can be new or simply building upon an existing profile. The profile protects user anonymity by using the UID as a proxy for the individual. The information stored in the database may be, inter alia, time/date information, initial home and/or default page information, location information such as that derived from the server or access point IP address or ID, specific identifier information for the user (e.g., MAC address, etc.), additional information provided by third parties who wish to exchange existing user/device information and/or store this third party information indexed by the UID for future transactional reference, as well as any other information acquired by the DTD Server 160 at this time. As a result of survey and profile engine processing, survey questions specific to each user are generated based upon the acquired information. DTD Server 160 then transmits first data such as a terms and conditions (T&C) page with these survey questions to the user. The user may then answer the survey questions and acknowledge the terms and conditions, for example, by selecting an “accept” button. In response to receipt of this acceptance, the DTD Server 160 can open or instruct the network equipment to open a network connection for the user. The DTD Server 160 also then stores the survey answers as well as any new or related user identifier information in a database. Additional processing related to this new (e.g., survey) information is performed by the DTD Server 160. As a function of this additional processing, the DTD Server 160 opens up (or instructs network hardware to open) a client port on the local server and redirects the user to a splash page (also known as landing page) determined as a function of user identifier information with components customized for that individual. Suitable splash pages may be retrieved and stored in network cache. Finally, a local splash page, determined as a function of the access device location, is sent to the user's browser. Furthermore, all of the content transmitted to the user (e.g., first data, splash pages, etc.) may be formatted and/or indexed to the specific type of access device utilized by the user, as determined by the DTD Server 160. The cumulative profile generated by DTD can be accessed for future use during that session or sessions that follow.

In an exemplary technique regarding how information including survey questions may be generated, transmitted, and processed, according to one or more embodiments of the invention, the identifier is first queried against an identifier algorithm engine to determine if a profile exists for that user and, if so, which survey questions the user has already answered. Based on location, stored user profile information, and user responses, the DTD Server may decide to serve additional, unanswered survey questions. As a function of these determinations, any outstanding survey questions are associated with the terms and conditions (T&C) page. The DTDS 160 then transmits the T&C page with the survey questions. A location page may also be served as a function of server ID, location, IP address, etc. In some embodiments, the information received typically enables the Profile Engine to serve up targeted advertisements (e.g., banner ads, rich media, video, audio, and other content keyed to user information such as location, user profile information, etc.), sponsor logos, and pages such as first pages, splash pages, etc.

In another exemplary technique regarding how information may be collected and processed when an XML gateway or Radius based implementation is used, according to one or more embodiments of the invention, an XML Serving component of the DTD server may forward information such as identifier information (e.g., the MAC address of the access device), the bandwidth allowed to the user, and a session expiration time to the DTD Server. The DTD Server then opens up a port on the local server and redirects the browser to a splash page based on identifier and location information. The DTD Server may also retrieve user identifier information and downloads a splash page and local advertising information based on the associated user profile. DTD Server 160 may also access port numbers of the XML component to implement separate channels for acquiring or providing data to/from end users, advertisers, and content providers via this “back-door” technique. Radius server component could also accomplish similar data acquisition or provision based on Radius records that exist in a Radius-based environment, such as log-in files and history. However, in some embodiments of the present invention, intra-cell blocking to prevent client-to-client snooping is accomplished using without-radius technology.

In other data gathering and reporting functions performed by one or more embodiments of the present invention, aggregate information may be collected by a report engine, such as the number of new and repeat users at a given location. The report engine may parse these new and repeat user statistics according to location, geography, region, and other characteristics of user service. In some embodiments, a list of user-activity trend reports may be generated such as, for example, the top 100 default home pages used by users. Such trend information could be used to target potential web sites or advertisers to generated revenue for the UN network and targeted content delivery service. A simple profile can be created without knowing any personal information of an end user, but enough information may complied by eventually to offer relevant content based on the current location and time of day the user has accessed the network. In some embodiments, Pool IDs (PIDs) are created and a user profile may be associated with multiple Pools. A Pool is a high-level survey-based grouping that may be inferred based on survey results. Sub Pool IDs may also be used to provide a hierarchical relationships for sub-groups within these Pools. Other Pool-related data that may gathered and/or stored include, a Historical Profile Pool ID, which may include the evolution history of an identifier profile (e.g., a MAC profile), a Historical Location ID & Usage Counter, Historical Survey ID & Response, Survey Results Per Location, and all other combinations of Pool-related data with any user or profile related data maintained by any of the processing components.

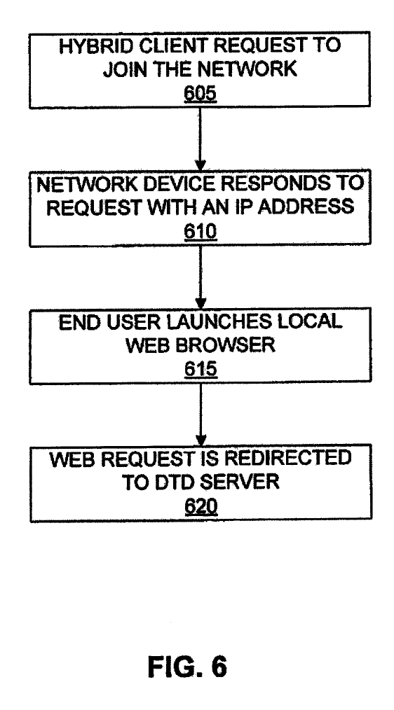

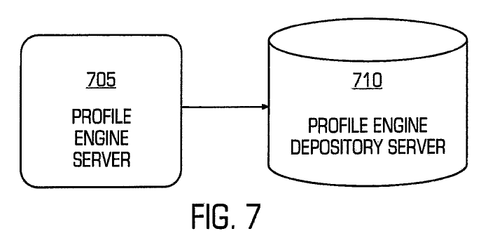

FIGS. 6-7 are flow diagrams illustrating some functionality of one or more embodiments of the present invention. Each step of embodiments of the algorithms shown in FIGS. 6-7 is demarked with a numerical identifier, 605 through 710. The description of each step, in association with its numerical identifier, is set forth below.

In step 605, as shown in FIG. 6, a user connects to a hybrid network via any known mechanism, such as by a Wireless or an Ethernet connection. The access device (for example a PC, PDA, or Wi-Fi Phone) requests an IP address from a Routing/Connectivity or network device such as a local Dynamic Host Configuration Protocol (“DHCP”) server.

In step 610, the RCD or network device assigns an IP address to the access device. An access device identifier, such as the MAC address, is then registered in the RCD or network device and is placed in a pending status. When this identifier (i.e., MAC address, in the present example) is first seen on the network or a user registers to the system, the DTD Server instantly creates a profile ID and database record based upon this identifier information.

In step 615, the end user now launches a local web browser which makes its initial request to go to the user default home page.

In step 620, the RCD or network device intercepts the request and redirects the request to the DTD Server on the network, while also transmitting the identifier (e.g., here, MAC address), local IP address, and original home page URL, along with the network device IP address and other specific identifier information.

As shown in FIG. 7, a profile engine server may perform Profile Engine algorithms 705 on the data. The Profile Engine algorithms are based on a scaling value counter system, where value is given to every interaction of the identifier or MAC address (for example, a MAC address may be profiled on the number of times it has used the network, or it may be profiled by answered survey questions). As the Profile engine builds a profile using an identifier, it also places the information in associated bit buckets. Requests are then paired up with lose associated bit buckets and then mapped to sponsor advertisements profile(s). Finally, association of each sponsor is made to each location. The results are then stored in the Profile Engine Depository Server 710.

In one exemplary process, the DTD Server 160 receives a request for the local Terms & Condition (T&C) Page from the end user. During these initial exchanges, the following exemplary information may be acquired by the DTD Server and recorded in the Profile Engine: identifier information such as end user MAC Address, Local IP Address, Default Home Page URL, RCD and/or Network Device ID, Network IP Address (e.g., for RCD, Network Device, etc.), Location ID, Local Language on Computer, Operating System/Device Specific Information, Nest Requested Home Page, Survey Results, Date and Time Information, as well as other information derived from the access device, the user's behavior, or information concerning the user generated at or by the RCD.

Next, the DTD Server checks against the DB to see if the identifier acquired has an existing profile (profile ID) associated with it. If there is no profile ID, then the identifier is added to the profile Engine and assigned a Profile ID. The location ID is then checked against the location profile database to see if the profile tag is set to on or off. The profile tag is set to “off” if the identified user has an existing profile and answers to all of the survey questions are on file. If the profile engine is in need of the answers to outstanding survey questions, the profile tag is set to “on.” If the profile tag is set to off, then a Local T & C page is forwarded to the requesting end user's browser.

Then, if the profile tag is set to on, the location T & C Page is matched up with the user profile ID as well as the required survey question(s), which are forwarded to the end user browser by instruction from the DTD Server. The end user would never see the same survey question asked across any location on the network, since DTD Server tracks the identifier throughout the network.

Next, first data such as a welcome page with Terms & Conditions (T & C) is transmitted to the end user. This return page is already formatted to the device type, screen size, and format, which is/are specifically tuned to the device's capabilities. The end user may then be asked to accept or decline the T & C page condition. If a survey question is also provided here, the user has to answer the question in order to move forward.

If the user clicks on the disagree button (regarding the T&C's), the user browser is redirected to a courtesy page requesting him or her to disconnect from the network. Alternately, a processing component may respond to a disagree selection by providing a less then full-service web experience. For example, a DTD Server may restrict the user's time or bandwidth on the network, or offer reduced guarantees of priority, traffic, and/or other performance characteristics as compared to those provided via acceptance of the terms and conditions. In some cases, these restrictions may be implemented by permitting basic web-browsing while blocking Virtual Private Networks, thus preventing a user, such as a corporate user, from accessing email or using other important features associated with such networks. Restrictions may also be implemented by introducing jitter and/or delay to the extent that VoIP performance and real-time streaming of video services are not feasible or satisfactory, though browsing the web is still possible.

If the user clicks on the Accept button, another request is sent to the DTD Server to activate a user's pending status to active status so they can now use the Internet freely. This is the unrestricted mode of using the access network, which allows the user to utilize all of the features and functionality of the Internet. However, access can still also be moderated by a pre-determined and/or real-time access control system. Such moderation or control may enable determination of the actual bandwidth and other performance characteristics contemplated. For instance, if certain identifiers have been pre-programmed within the network to restrict VPN access, then any policies of specific user access can be implemented at this stage. Next, a splash page is transmitted to the user and a connection is opened.

In further processing, the DTD Server may register the request and time of the request in an associated database. If the request includes responses to survey answers, then they are forwarded to the Profile Engine, and survey answers may be updated against data already stored for that user in the Profile Engine.

Here, the DTD Server now transmits some commands to the network device to activate the pending status, set the upload and download bandwidth speed per the identifier, and set an expiration time of when the user's session will expire for that network.

Next, the user's Location ID is checked to see if it has a sponsor associated with that location. If there is no sponsor a generic local splash page will be sent to the requesting user. If a sponsor is associated with that location ID based on the location profile database, a splash page with relevant local information, and a targeted advertisement based on the user's profile ID will be sent to the user.

Again, the profile engine server may perform the Profile Engine algorithms on the data. The Profile Engine algorithms are based on a scaling value counter system, where value is given to every interaction of the identifier or MAC address (for example, a MAC address may be profiled on the number of times it has used the network, or it may be profiled by answered survey questions). As the Profile engine builds a profile using an identifier, it also places the information in associated bit buckets. Requests are then paired up with lose associated bit buckets and then mapped to sponsor advertisements profile(s). Finally, association of each sponsor is made to each location. The results are then stored in the Profile Engine Depository Server.

Regarding, in particular, the wireless implementation addressed above, the present invention provides particular advantages pertaining to direct access, location, traffic and network operations. With respect to direct access, the present invention provides direct connection to the customer and eliminates third party involvement in the delivery of content, as well as allowing for the licensee/subscriber/vendor to be the starting point of each and every communication (e.g., page, flash page, search, etc.) with the customer. With respect to location, the present invention provides the exact location of the customer, providing significantly greater value to related advertising and information. In other words, the more granular the information is about the customer, the more valuable it is to the advertisers (e.g., for directed advertising and other communications). Alternately, a more generalized location may be provided for the customer, such as region, zip code, etc., to protect user anonymity. With respect to traffic considerations, the cost methodologies addressed herein provide for greater accessibility, as costs present a significant competitive barrier. Specifically, embodiments of the present inventive methodology can provide free access by users, rather than requiring some sort of direct revenue from the end-user (although there can be fees associated with each subscription). Thus, regarding the maximization of traffic, these embodiments are particularly advantageous for networks that are: (1) carrier class, (2) easy to log onto, and (3) ubiquitous. Finally, with respect to network operations, the present methodology provides relatively low equipment costs with respect to prior network access of this nature, as well as the capability of avoiding the expenses of otherwise implementing/managing a network of this quality.

The technology set forth herein has particular applicability to the operation of WiFi networks, and especially companies closely associated with WiFi technology. The systems and methods of the present invention provide numerous advantages in the areas of network management and operation, data collection and aggregation, real-time provision of user demographics, location and other information, and reporting of WiFi network usage (summaries, aggregates, even real-time). For example, the WiFi embodiments have specific applicability to service providers, portals, and internet ad intermediaries.

For example, these WiFi embodiments provide unique advantages to service providers like VoIP (voice over IP) internet telephony companies, such as authentication/authorization of the telephones on log-in, logging of the calls for statistics and billing, network management (e.g., bandwidth, ports, etc.), and security management (e.g., firewall, eliminating unwanted third parties, etc.). These WiFi embodiments also provide significant advantages to portals, such as real-time user demographics and location that allow for immediate, directed advertising. These WiFi embodiments also provide significant advantages to internet ad intermediaries, such as information management applicable to all of the many layers of service providers involved in having an ad (e.g., banner) displayed on a web page.

In another exemplary implementation, the present invention may help prevent click-fraud, or other activity of interest performed by users of the network. Here, the DTD server 160 has information about identifiers (such as MAC addresses) of every device on the network. This information can be associated with the cumulative number of clicks (on advertisements, marketing media etc), which can then be used to trigger a further audit if there is an anomalous number of clicks. This may allow an operator of the network, for example, to provide information about such anomalous behavior. This can be important, as the total number of clicks can be also traced to the number of clicks on a particular website and/or a particular advertisers advertisements or content. As a result, the invention can be used as both an alerting mechanism and then a tracing mechanism to monitor and prevent click-fraud. In addition, if it is required, access to the network can be blocked for the offending device based on its identifier, so the user cannot access the network and continue with fraudulent or non-compliant practices.

In a further exemplary implementation, the present invention may also provide benefit in the areas of security and access control. Again, since user identifiers (such as MAC address) are known in the network, they can be mapped into dynamic databases which are used as a secondary mechanism of physical machine verification for access to networks, websites, and/or specific classes of digital content on a network or networks. Since the DTD Server has a database of all devices, it can interface with a large number of third-party databases. For example, it can interface with databases of allowed users who have high priority for access to the network in case of an emergency response situation, such as one directed, for example, to the whole network or just to a specific geographic location. Therefore, multiple classes of access, rules, syntax, and associations of such databases are done inside the DTD Server, enabling the network to develop intelligent rules for access to services and content based on unique combinations of these databases, and apply them to the identifier of the device.

In yet another exemplary implementation, the present invention may also provide benefit in the area of rule-based blocking of content. Specifically, the DTD Server may be employed to ensure that “no” content is delivered when none is desired. This functionality may be applicable, for example, when a network TV broadcast is scheduled for particular show times in certain regions in the world, or when movies and other digital content, such as music, are released in a carefully controlled fashion in a network. By having rules associated with content of this type, the DTD Server can determine if the user has the rights to receive and play the appropriate content. Such rights not being based solely on traditional DRM techniques, but rather on the time, location, and other parameters that the content provider can specify. For example, if an online program is released in Australia, with a release time scheduled hours later in New York, then the content provider can tag the content such that it cannot be downloaded and/or played until the appropriate release time determined by the content creator/distributor. Utilization of specific user identifiers ensures a layer of digital rights management enforceable via the network by association of the identifier and the DTD Server, by virtue of database interfaces, with the content rights and rules to be enforced by the content distributor.

Appendix A is incorporation here by reference in its entirety.

Other embodiments of the invention will be apparent to those skilled in the art from consideration of the specification and practice of the invention disclosed herein. It is intended that the specification and examples be considered as exemplary only, with a true scope and spirit of the invention being indicated by the disclosure above in combination with the following paragraphs describing the scope of one or more embodiments of the following invention.

1-109. (canceled)

110. A method of engaging users of an internet-access network comprising:
associating a processing component, having associated therewith processing software, with the internet-access network;
transmitting a request, associated with a user of an access device, for authorization to use the internet-access network, the request including identifier information for the user that specifies a unique identifiable address of the user access device;
receiving the request at a routing device coupling the user access device to the internet-access network;
acquiring information regarding the access device and the user of the access device from a targeting database server coupled to the internet-access network; and
transmitting the information regarding the access device and the user of the access device to a content server accessible through the internet-access network.

111. The method of claim 110 further comprising:
receiving content from the content server for transmission to the access device; and
transmitting first data including information based on a location of the access device, wherein the first data is determined by processing software as a function of the information for the user that specifies a unique identifiable address of the user access device.

112. The method of claim 111 wherein the information for the user that specifies a unique identifiable address of the user access device comprises an Internet Protocol (IP) address of the user access device.

113. The method of claim 111 wherein the information for the user that specifies a unique identifiable address of the user access device comprises a MAC address of the user access device.

114. A method of engaging users of an internet-access network comprising:
associating a processing component, having associated therewith processing software, with the internet-access network;
transmitting a request, associated with a user of an access device, for authorization to use the internet-access network, the request including access to a cookie-emulator that specifies a unique identifiable address of the user access device;
receiving the request at a routing device coupling the user access device to the internet-access network;
acquiring information regarding the access device and the user of the access device from a targeting database server coupled to the internet-access network; and
transmitting the information regarding the access device and the user of the access device to a content server accessible through the internet-access network.

115. The method of claim 114 further comprising:
receiving content from the content server for transmission to the access device; and
transmitting first data including information based on a location of the access device, wherein the first data is determined by processing software as a function of the information for the user that specifies a unique identifiable address of the user access device.
